(19) United States
(12) Patent Application Publication
(10) Pub. No.: US 2026/0365417 A1
(43) Pub. Date: Nov. 19, 2026

(54) PNEUMATIC ACTUATING VALVE FOR FIRING A PRESSURISED CONTAINER

(71) Applicant: Raul Horacio Aguirre Ontiveros, Chihuahua (MX)

(72) Inventor: Raul Horacio Aguirre Ontiveros, Chihuahua (MX)

(21) Appl. No.: 19/441,707

(22) Filed: Jan. 6, 2026

(30) Foreign Application Priority Data
Jan. 6, 2025 (MX) MX/E/2025/000484

(51) Int. Cl. B65D 88/70; F16K 31/122

(52) U.S. Cl. CPC B65D 88/703; F16K 31/1221

(57) ABSTRACT

The present invention relates to a pneumatically operated valve for discharging pressurised air into containers used for handling bulk materials. The valve consists of a central cap (1) with a two-inch threaded connection, a coupling cap (2) joined by screws and sealed with O-rings, a coupling cylinder (5) with equidistant side cavities, an actuating piston (6) that slides inside the cylinder, a compression spring (7) and a quick exhaust valve (10) installed on the central cap (1).

The assembly defines an internal valve chamber configured to generate axial displacement of the piston (6) by means of pressure differences between the air container tank and the environment. The valve is installed on a pressure vessel and allows the release of air flow in controlled cycles for air impact cleaning applications in industrial systems that handle solid materials.

### TECHNICAL FIELD

The present invention relates to a pneumatic actuating valve, which operates by air flow and pressure differences, in order to release a burst of compressed air (which is stored in a tank to which the valve is screwed). This air impact will be used for corrective and preventive cleaning in the event of material accumulation on surfaces in equipment such as: preheaters, coolers in cement plants, silos, hoppers, chutes, and similar material-handling equipment that handle material flow.

### BACKGROUND

Due to the constant problem of material accumulation adhering to the surfaces of storage devices, whether fixed or temporary, for bulk materials, technologies have been developed to clean the walls of these elements, such as those mentioned in the patents: U.S. Pat. No. 7,273,205B2, U.S. Pat. No. 3,788,527A, U.S. Pat. No. 4,346,822A, EP0021999A1, EP0134447B1, US4051982A, EP1993937A2, USRE48356E1, AU2005200140B2, US20110000936A1, AU2007226621A1, U.S. Pat. No. 5,853,160A, MXPA98004181A for various equipment. The objective of this invention is to improve the manufacturing experience, functionality, performance, and maintenance of the equipment covered by the aforementioned patents. These innovations are based on improvements in preventive and corrective maintenance times and methods, a reduction in moving parts, an increase in power, a reduction in response times, and ease of installation.

### BRIEF DESCRIPTION OF THE DRAWINGS

FIG. 1 is a section elevation view of a pneumatic action valve, according one or more embodiments.

FIG. 2 is a section elevation view of a third position for a pneumatic action valve, according one or more embodiments.

FIG. 3 is a section elevation view of a first position for a pneumatic action valve, according one or more embodiments.

FIG. 4 is a section elevation view of a pneumatic cannon, according one or more embodiments.

FIG. 5 is a section elevation view of a first position for a pneumatic action valve, according one or more embodiments.

FIG. 6 is a section elevation view of a third position for a pneumatic action valve, according one or more embodiments.

FIG. 7 is a perspective view of a pneumatic action valve, according one or more embodiments.

### DESCRIPTION

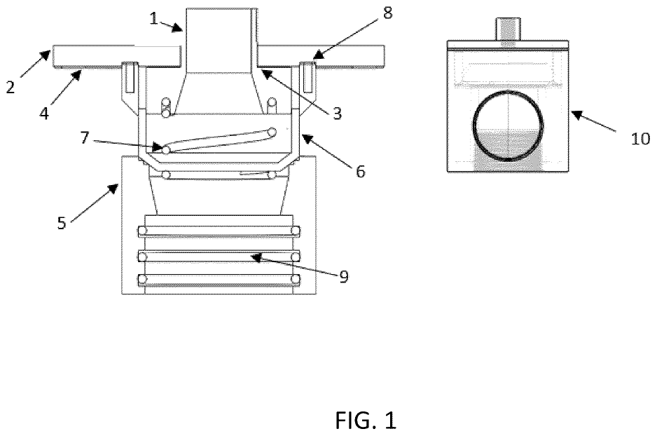

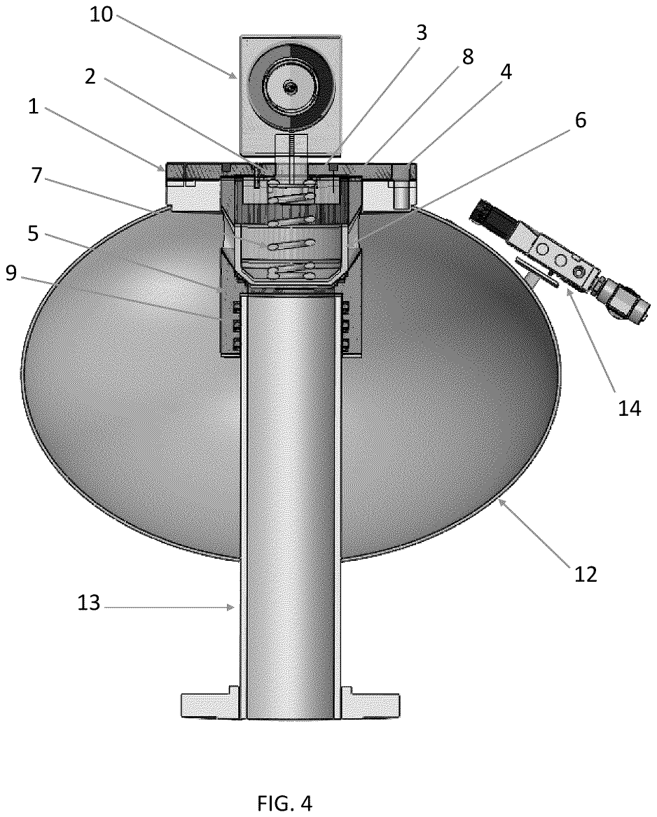

Pneumatic action valve (11) activated by pressure difference and air flow. The pneumatic action valve (11) is manufactured from 6061 aluminium by a machining process and is composed of 10 parts, which are specified and detailed in the sectional view of FIG. 1, FIG. 4:

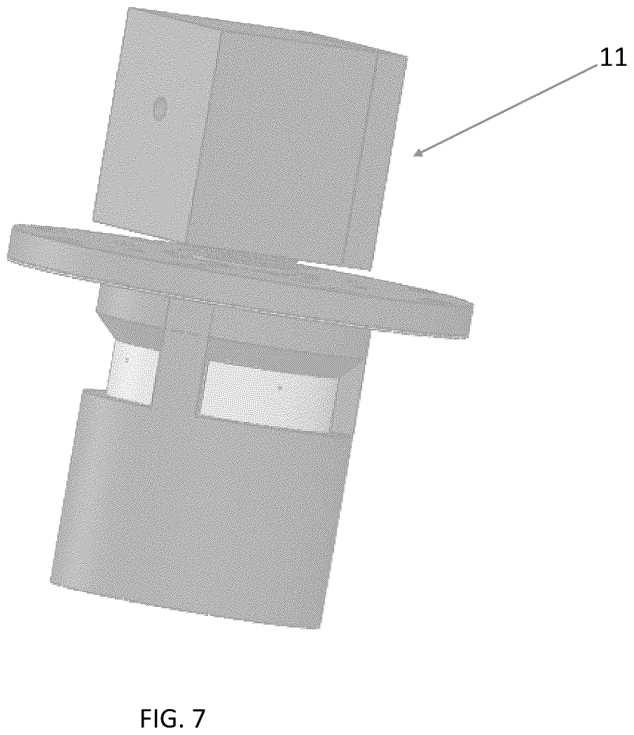

Central cap (1) with a two-inch external threaded connection at the top and a machined box at the bottom that houses the compression spring base (7). There is also a two-inch hole at the bottom of the central cap (1). The main function of the central cap (1) is to serve as the connection point between the quick exhaust valve (10) and the coupling cap (2). The coupling cap (2), which is removable and interchangeable, connects to an air container tank (12) via eight ⅝-inch holes distributed evenly around its perimeter. The main function of the coupling cap (2) is to serve as the mechanical connection point between the pneumatic valve (11) and an air tank (12). To achieve an efficient seal, a temperature-resistant 2-169 silicone O-ring (4) is placed between the air container tank (12) and the coupling cap (2) to prevent air leakage. The mechanical coupling between the central cap (1) and the coupling cap (2) is achieved using ¼-inch stainless steel screws. In turn, a set of 2-039 and 2-046 silicone O-rings (3) between the two elements, the central cap (1) and the coupling cap (2), whose function is to prevent air leaks between the two caps. The main cylinder (5) with an outer diameter of 6 inches is also screwed onto the coupling cap (2). The cylinder (5) consists of three air suction sections separated at 120 degrees from each other along the perimeter of the cylinder (5), FIG. 7. The cylinder (5) is manufactured from 6061 aluminium using a machining process, making it a single piece with no assemblies. It also has a grade III anodised surface finish and serves as the structural housing that connects to both the central cap (1) and the coupling cap (2). An 8 O-ring 2-011 (8) silicone seal is placed between the cap (1) and coupling (2) elements and the cylinder (5). The cylinder (5) also connects to the 4-inch outlet pipe (13) of the air container tank (12). To ensure proper sealing and prevent leaks in the connection, three O-rings 2-425 (9) are placed in three machined boxes on the lower inner diameter of the cylinder (5). Inside the cylinder (5), a 6061 aluminium actuating piston (6) slides, machined in one piece and with three 1/16-inch holes distributed evenly around its perimeter. This element slides internally in the cylinder (5) and is the main element for the operation of the main valve, having two main positions. The first is when the galvanised compression spring (7) is fully expanded. In this position, the valve is closed, which means that the actuating piston (6) seals with the cylinder (5) at the bottom of the cylinder (5) by means of a triple seal that was machined into the cylinder (5), causing the air to be stored in the air container tank (12). The second position is when the compression spring (7) is compressed. This is the position where the main valve is activated and the air is released.

FIG. 4 illustrates a pneumatic cannon, which consists of four elements: air tank (12), pneumatic valve (11), control element (14) and 4-inch outlet tube (13).

### Operation

The pneumatic action valve (11) must be mounted on an air container tank (12) to begin operation. In turn, the air container tank (12) is mechanically installed on the walls of the container from which the material is to be removed. The pneumatic action valve (11) operates by means of air flow, which is controlled by a system of upstream control elements (14) such as: pressure regulator filter, check valve and 3/2 solenoid valve. Once the pneumatic action valve (11) is connected to the hose that supplies air flow from an external compressor, the process begins.

The valve operates on the principle of the movement of the actuating piston (6) by means of a pressure difference between the air contained in the air tank (12) and the environment. The air tank (12) is the main air concentration chamber to which the pneumatic action valve (11) is connected at two points, the first at the top with the coupling cap element (2) and the second at the bottom with the cylinder element (5), FIG. 4. The air tank (12) is at a specific pressure, which ideally should be 60 to 90 PSI or as determined by the operator.

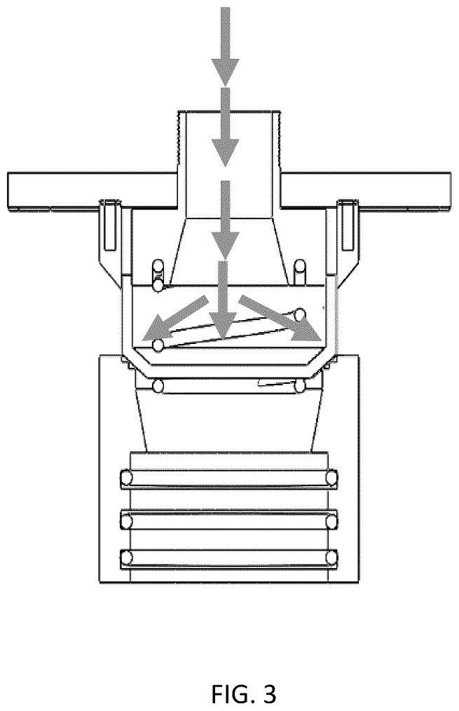

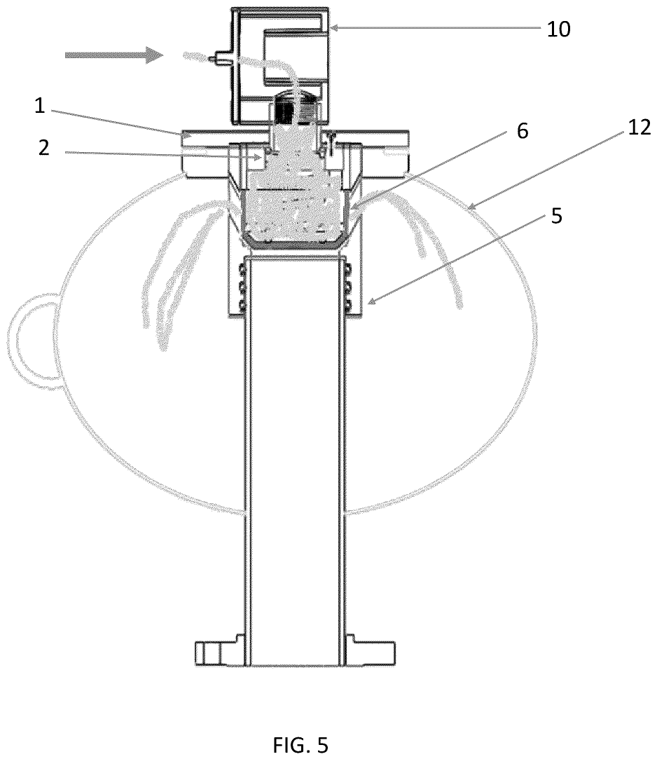

The first position, FIG. 3, illustrates the flow of air inside the pneumatic action valve (11) with arrows, FIG. 5, which represents with an arrow the flow of air from the pneumatic action valve 11 to the air container tank (12), which is called the air charge position. This is when air is supplied to the valve through a two-inch quick exhaust valve (10). The air flows through the quick exhaust valve (10), passing through the central cap (1) through a 2-inch diameter, immediately after passing through the central cap. (1), the air passes through the main cavity of the cylinder (5) and continues to flow until it hits the actuating piston (6). At this point, the air begins to flow through three 1/16-inch holes evenly distributed on the side wall of the cylinder (6). Once the air flows through these holes, the air container tank (12) begins to fill with air. This process is continuous until the desired working pressure is reached, 90 PSI (ideally), and this position ends when the device has reached the desired pressure.

Second position, FIG. 3, which is the rest position, where the air flow continues with the same process as position 1 to maintain the pressures; at this point, there is no further increase in pressure.

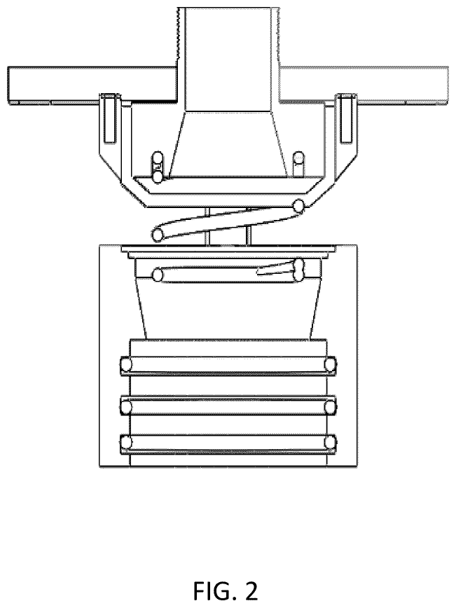

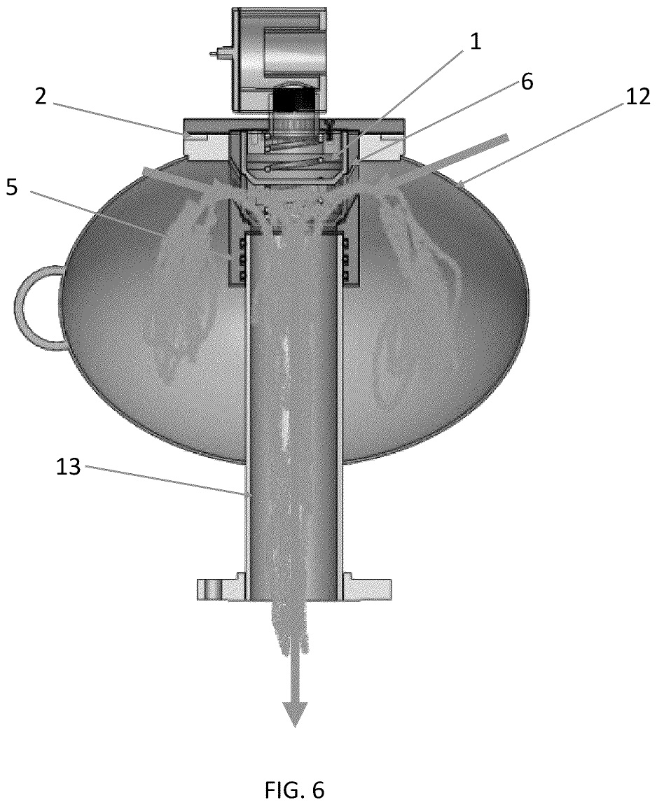

Third position, FIG. 2, FIG. 6: Once the pneumatic action valve (11) is activated by the control elements (14), position three begins, in which the supply air flow is cut off through the two-inch quick exhaust valve (10). The air supply to the quick exhaust valve (10) stops, causing the quick exhaust valve (10) to come into contact with ambient pressure. causing the quick exhaust valve (10) to begin to displace air (negative pressure) from the pneumatic action valve (11), causing a flow from the actuating piston (6) to the outlet of the quick exhaust valve (10). This air flow generates suction in the system, causing the actuating piston (6) to slide through the cylinder (5) until it mechanically hits the coupling cap (2). This process takes 0.13 seconds. Once this time has elapsed, the control elements (14) return to their initial position and the pneumatic action valve (11) returns to its first position.

While at the top of the pneumatic valve (11), in the cylinder (5) the actuating piston (6) has risen until it is covered by the coupling cap (2), at the bottom of the pneumatic action valve (11), the actuating piston (6) has stopped sealing with the triple seal of the cylinder (5), leaving the 4-inch outlet of the cylinder (5) free, which is connected to the 4-inch outlet pipe (13) for air outlet from the air container tank (12).

This action, which takes place in 0.13 seconds, causes the air contained in the air tank (12) to flow through the cylinder (5) and the 4-inch outlet pipe (13) at high speed and pressure, generating a high-pressure air blast.

Cycle: After completing the cycle from position 3, the valve returns to position one and the cycle repeats.

1. Pneumatically operated valve for firing pressurised containers, comprising a central cap (1) with a male thread at the top and a 2-inch bore at the bottom, a coupling cap (2) secured by screws and sealed by O-rings (3)(4), a coupling cylinder (5) connected to the coupling cap (2) and provided with an outer diameter of 6 inches, an actuating piston (6) slidable within the cylinder (5), a compression spring (7) and a quick exhaust valve (10) installed at the top of the central cap (1), characterised in that the outlet of the central cap (1) has an internal diameter of 2 inches that communicates directly with the quick exhaust valve (10), together with the cylinder (5) and the piston (6) defining an internal discharge chamber (“valve chamber”) configured to generate a pressure difference that axially displaces the piston (6) during firing.

2. The valve according to claim 1, characterised in that the valve chamber is structurally defined by the central cap (1), the coupling cylinder (5) and the upper face of the actuating piston (6), with adjustment tolerances between the central cap (1) and the piston (6) that restrict flow during the firing cycle.

3. The valve according to claim 1, characterised in that the coupling cylinder (5) incorporates three machined contact points on its contact surface with the actuating piston (6), forming a triple sealing base between the cylinder (5) and the actuating piston (6).

4. The valve according to claim 1, characterised in that the coupling cylinder (5) and the actuating piston (6) are manufactured from 6061 aluminium in a single piece by a machining process, and the cylinder (5) has a type III anodised coating.

5. The valve according to claim 1, characterised in that the coupling cylinder (5) comprises three equidistant side cavities at 120 degrees, configured as air transfer ports between the tank and the valve chamber.

6. The valve according to claim 1, characterised in that the coupling cap (2) is removable from the central cap (1), allowing it to be replaced to adapt to different flange or tank patterns.

7. The valve according to claim 1, characterised in that the central cap (1) includes an internal axial cavity for housing the compression spring (7), keeping it guided during the movement of the piston (6).

8. The valve according to claim 1, characterised in that the quick exhaust valve (10) has a diameter of 2 inches at its inlet and outlet, coinciding with the internal diameter of the lower outlet of the central cap (1), to maintain a direct flow path without obstructions.
